(19) United States
(12) Patent Application Publication
(10) Pub. No.: US 2007/0295308 A1
(43) Pub. Date: Dec. 27, 2007

(54) Common Rail System With Differently Embodied Supply Lines To The Injectors

(76) Inventors: Holger Rapp, Ditzingen (DE); Marcus Schilling, Weingarten (DE)

Correspondence Address: RONALD E. GREIGG;GREIGG & GREIGG P.L.L.C., 1423 POWHATAN STREET, UNIT ONE, ALEXANDRIA, VA, 22314, US

(21) Appl. No.: 11/632,970

(22) PCT Filed: May 20, 2005
(86) PCT No.: PCT/EP05/52322

§ 371 Date: Jan. 19, 2007

(30) Foreign Application Priority Data
Jul. 21, 2004 (DE) 10 2004 035 297.6

(51) Int. Cl. F02M 41/00

(52) U.S. Cl. 123/456

(57) ABSTRACT

A common rail fuel system essentially comprising at least one rail, at least two injectors, and a respective supply line of a definite length between the rail and each injector. In order to prevent oscillation-generated movements of one supply line from being transmitted to the adjacent supply lines, the respective adjacent supply lines are embodied with different natural frequencies as a result of the supply lines of a rail being of different dimensions, for example different lengths.

The invention relates to a common rail system, essentially comprised of

at least one rail,

at least two injectors, and

at least one respective supply line of a definite length between the rail and each injector.

### PRIOR ART

In the current prior art, the common rail system is essentially comprised of a rail that is acted on with high pressure by means of fuel. Supply lines lead from the rail and, at their ends oriented away from the rail, terminate at the so-called injectors, which are in turn provided to inject the highly pressurized fuel supplied from the rail into a combustion chamber.

In the current prior art, for reasons of symmetry, all of the supply lines from the rail to the respective injectors in a common rail system are embodied as being of the same length and as a rule, are also provided with the same internal diameter.

### DISADVANTAGES OF THE PRIOR PART

This symmetrical embodiment of the supply lines from the rail to an injector, with the same length and the same internal diameter has the disadvantage that these lines have the same resonance frequency.

Because of the high pressure prevailing inside the rail and therefore also in the supply lines in the injectors, pressure oscillations occur in the supply lines when there is a change in the quantity of fuel requested. This in turn results in the fact that the pressure oscillation generated in one supply line also generates oscillations in the adjacent supply lines. As a result, additional wear occurs—particularly at a nozzle seat inside the injector—due to the transmission of the pressure oscillation from an adjacent supply line.

### OBJECT OF THE INVENTION

The object of the present invention is to prevent or at least reduce a transmission of a resonance oscillation from one supply line of a common rail system to adjacent supply lines.

### ATTAINMENT OF THE OBJECT

The concept for attaining the object of the invention is to prevent the individual supply lines, which are respectively situated between the rail and each injector, from having the same resonance frequency as one another.

According to one proposed attainment of the object, the resonance frequency of the respective supply lines is changed, for example, in that the supply lines between the rail and the injector are embodied with different lengths. Alternatively, it is also possible for the diameter or the wall thicknesses of the supply lines to respectively differ from one another.

### ADVANTAGES OF THE INVENTION

According to the present invention, the pressure oscillations occurring in the common rail system and in particular the wear on the nozzle seat of an injector due to the oscillations are reduced in that at least the oscillations that are generated by the adjacent supply lines are not transmitted to a particular supply line.

The actual resonance frequency essentially results from the total line length of the supply line.

But there are also other possibilities known from the prior art for changing the corresponding resonance frequencies.

In order to achieve a particularly favorable effect and to correspondingly prevent an oscillation, the resonance frequencies of the individual supply lines should differ by more than 50 Hz.

In order to also prevent a transmission of resonance oscillations of different orders of magnitude, it is also necessary to avoid ratios of the overall line lengths of (2×n+1)/(2×m+1), where n and m are each natural numbers between 1 and 4.

In common rail systems with more than one rail, e.g. in V engines, it is only necessary for the lengths of the supply lines of a particular rail to differ from one another. By contrast, different rails can each have one instance of the same line length. Thus, for example in a V-6 arrangement with two rails, only three different line lengths are required.

Other advantageous embodiments ensue from the following description, the drawing, and the claims.

### DRAWING

FIG. 1 schematically depicts a common rail system with supply lines of respectively different lengths.

### DESCRIPTION OF AN EXEMPLARY EMBODIMENT

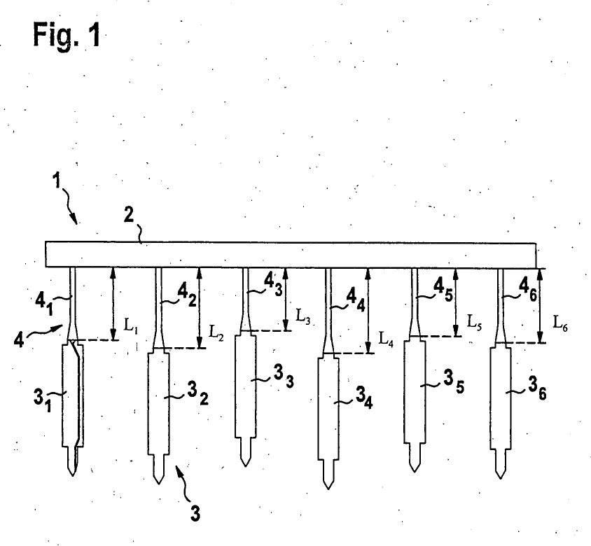

FIG. 1 shows a common rail system 1 comprised of a rail 2 and injectors 3; a respective supply line 4 is situated between the rail 2 and each injector 3. Each supply line has a length L, which represents the length L from the rail 2 to the injector 3.

In the exemplary embodiment shown here, a rail 2 is provided with six injectors 3₁ through 3₆; respective supply lines 4₁ through 4₆ are provided between the rail 2. The lengths of the respective supply lines 1 are labeled with the reference numerals 1₁ through 1₆.

In order to prevent a transmission of a resonance oscillation, for example from a first supply line 1₁ to the remaining supply lines 1₂ through 1₆, according to the present invention, the supply lines 1₁ through 1₆ are embodied with different lengths so that they each have a different first resonating frequency.

In order to prevent a corresponding transmission from also occurring in the range of the harmonics, it is necessary to determine the selected length of each respective supply line as follows:
(1x+1i)/(1y+1i)?(2n+1)/(2m+1),
where N and M are each natural numbers.

1-4. (canceled)

5. In a common rail system, essentially comprised of at least one rail, an arbitrary number n of injectors, and an arbitrary number n of supply lines of a definite length L between the rail and each injector, the improvement wherein the dimensions of the respective supply lines differ from one another.

6. The common rail system according to claim 5, wherein the length of each respective supply line differs from that of the adjacent supply lines.

7. The common rail system according to claim 5, wherein the natural frequencies of the respective adjacent supply lines differ from one another by at least 50 Hz.

8. The common rail system according to claim 6, wherein the natural frequencies of the respective adjacent supply lines differ from one another by at least 50 Hz.
